(19) United States
(12) Patent Application Publication
(10) Pub. No.: US 2022/0087296 A1
(43) Pub. Date: Mar. 24, 2022

(54) FLAVORED MELT FORMULATION

(71) Applicant: Javamelts, Inc., Smithtown, NY (US)

(72) Inventor: Carolyn Barbarite, Smithtown, NY (US)

(73) Assignee: Javamelts, Inc., Smithtown, NY (US)

(21) Appl. No.: 17/540,427

(22) Filed: Dec. 2, 2021

Related U.S. Application Data
(63) Continuation-in-part of application No. 16/022,875, filed on Jun. 29, 2018.

(51) Int. Cl. A23L 27/00; A23G 3/42; A23G 3/48; A23G 3/34; A23L 27/28

(52) U.S. Cl. CPC A23L 27/86; A23G 3/42; A23G 3/48; A23L 27/28; A23L 27/88; A23G 3/0038; A23G 3/0027; A23L 27/84

(57) ABSTRACT

A flavored melt is provided. The flavored melt includes a baked sugar composition, where the baked sugar composition includes at least sugar, water, one or more natural or artificial flavorings, and one or more bitter blockers.

### CROSS-REFERENCE TO RELATED APPLICATIONS SECTION

This application is a U.S. Non-Provisional patent application and Continuation-in-Part (CIP) Patent Application that claims priority to U.S. Non-Provisional patent application Ser. No. 16/022,875, filed on Jun. 29, 2018, the entire contents of which are hereby incorporated by reference in their entirety.

### FIELD OF THE EMBODIMENTS

This invention relates to flavored melts and, in particular, to the manufacture of flavored melts including bitter blockers.

### BACKGROUND OF THE EMBODIMENTS

Coffee is widely drunk throughout the world. For many individuals, it is a staple of their morning. The drinking of coffee has become so prevalent that coffee houses have opened worldwide that are primarily dedicated to selling it.

Although coffee's popularity is vast, it is well-known that coffee is bitter. This also applies to other common beverages, such as, e.g., tea, cappuccino, and espresso. This bitterness has turned many people away from these types of beverages and has caused many people to add sweeteners to overpower the bitter flavor. These sweeteners, however, add sweet flavoring to the beverage, while retaining the bitterness. A solution is thus needed by which the bitterness of a bitter beverage is blocked.

Examples of related art are described below:

U.S. Pat. No. 1,841,432 generally describes processes of coloring and flavoring sugar, and to the products resulting from the practice of these processes.

U.S. Pat. No. 2,807,559 generally describes sugar compositions and, more specifically, sugar in lump, cube, or aggregated forms.

U.S. Patent Publication No. 2006/0286277 generally describes a method for making a high quality spice sugar cube. The spice sugar cube consists essentially of sugar or a sugar substitute and at least one spice. A quantity of spice and a volume of sugar are measured. A first portion of about one third of the volume of sugar is dissolved in water to create a sugar water solution. The sugar water solution is heated until the solution reaches a temperature between 215 and 235 degrees Fahrenheit resulting in an amount of the water evaporating (e.g., boiling out) from the solution. The solution is than allowed to cool to between 80 and 120 degrees Fahrenheit. The quantity of spice is then mixed into the solution, and then the remaining portion of the volume of sugar is mixed into the solution to form a mixture. The mixture is then poured into a flat pan and pressed to remove any voids and cut into cubes.

European Patent Publication No. EP607991A2 generally describes brown cube sugar produced with crystalline white sugar and a syrup containing colors, flavors, and trace elements as ingredients. The invention also relates to a method for producing brown cube sugar, wherein crystalline white sugar is treated with steam or a steam-water mixture with simultaneous agitation, a syrup containing colors, flavors, and trace elements is mixed with the moist sugar, and the mixture is formed into cubes by methods known per se in the art of cube sugar production.

None of the art described above addresses all of the issues that the present invention does.

### SUMMARY OF THE EMBODIMENTS

According to an aspect of the present invention, a flavored melt is provided. The flavored melt includes a baked sugar composition, wherein the baked sugar composition includes sugar, water, one or more natural or artificial flavorings, and one or more bitter blockers.

It is an object of the present invention to provide the flavored melt, wherein the baked sugar composition is formed into a desired shape.

It is an object of the present invention to provide the flavored melt, wherein the sugar includes one or more sugars selected from the group consisting of: baker's sugar; brown sugar; dark brown sugar; and caramel powder.

It is an object of the present invention to provide the flavored melt, wherein the one or more natural or artificial flavorings are selected from the group consisting of chocolate flavored powder; cocoa powder; and vanilla flavor.

It is an object of the present invention to provide the flavored melt, wherein the flavored baked sugar composition further includes food coloring.

It is an object of the present invention to provide the flavored melt, wherein the baked sugar composition further includes salt.

It is an object of the present invention to provide the flavored melt, wherein the baked sugar composition further includes sodium carboxymethylcellulose.

According to another aspect of the present invention, a method for forming a flavored melt is provided. The method includes blending a plurality of ingredients of a baked sugar composition, wherein the plurality of ingredients includes sugar, water, one or more natural or artificial flavorings, and one or more bitter blockers. The method further includes placing the blended ingredients into an internal cavity of a mold, removing the blended ingredients from the mold, wherein the blended ingredients retain a shape of the internal cavity, and baking the blended ingredients in the shape of the internal cavity, forming the flavored melt.

It is an object of the present invention to provide the method for forming the flavored melt, wherein the sugar includes one or more sugars selected from the group consisting of: baker's sugar; brown sugar; dark brown sugar; and caramel powder.

It is an object of the present invention to provide the method for forming the flavored melt, wherein the one or more natural or artificial flavorings are selected from the group consisting of chocolate flavored powder; cocoa powder; and vanilla flavor.

It is an object of the present invention to provide the method for forming the flavored melt, wherein the baked sugar composition further includes food coloring.

It is an object of the present invention to provide the method for forming the flavored melt, wherein the baked sugar composition further includes salt.

It is an object of the present invention to provide the method for forming the flavored melt, wherein the baked sugar composition further includes sodium carboxymethylcellulose.

It is an object of the present invention to provide the method for forming the flavored melt, wherein the method further includes cooling the flavored melt after baking the blended ingredients.

It is an object of the present invention to provide the method for forming the flavored melt, wherein the method further includes packaging the flavored melt after cooling the flavored melt.

### BRIEF DESCRIPTION OF THE DRAWINGS

FIG. 1 shows a method for forming flavored melts, according to an embodiment of the present invention.

FIG. 2 shows a system for forming flavored melts, according to an embodiment of the present invention.

FIG. 3 shows another method for forming flavored melts, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

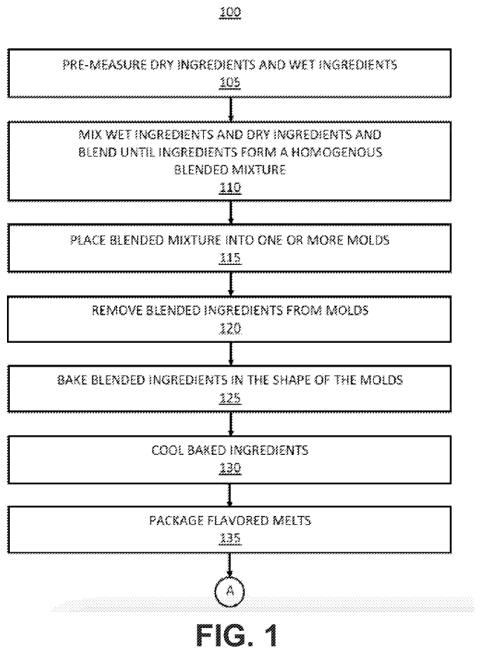

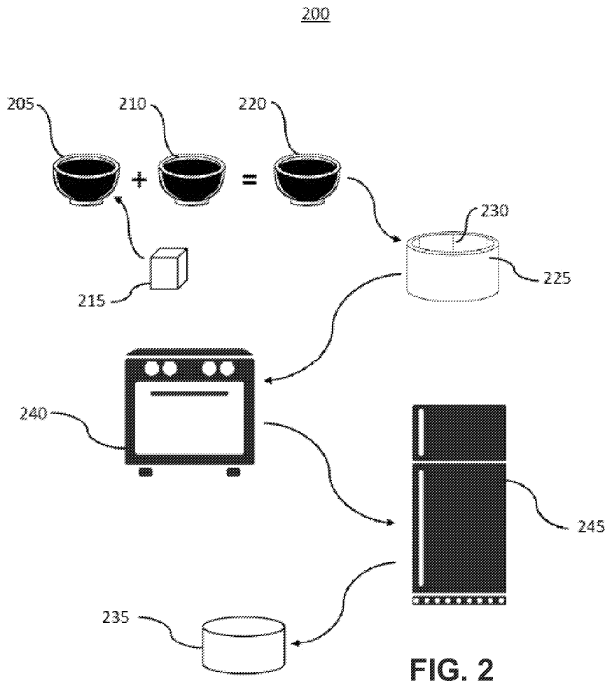

A method 100 for forming flavored melts is illustratively depicted in FIG. 1. The method 100 of FIG. 1 begins at a process step 105, which includes premeasuring a pre-determined mixture of dry ingredients 205 (as shown in a system 200 of FIG. 2) and wet ingredients 210. According to an embodiment, the wet ingredients 210 may include: water, food coloring, and/or any other suitable liquid ingredients. According to an embodiment, the dry ingredients 205 may include: baker's sugar, brown sugar, dark brown sugar, caramel powder, sodium carboxymethykellulose, salt, chocolate flavored powder, cocoa powder, vanilla flavor, and/or any other suitable dry ingredients. It is further noted that, according to each embodiment of the present invention, the wet ingredients 210 and/or dry ingredients 205 include one or more bitter blockers 215.

The inclusion of the bitter blockers 215 enables the flavored melts 235 to block some or all of the bitter flavor from the beverage (e.g., coffee, tea, espresso, cappuccino, etc.), making the beverage smoother and tastier. By removing or decreasing the bitterness from the beverage, the flavored melt 235 makes the beverage more enjoyable, thus producing a direct benefit to the consumer of the beverage. Furthermore, unlike creamers, according to some embodiments of the present invention, the flavored melts 235 include no dairy. A lot of people who are either lactose intolerant or just looking to cut calories and fat grams by not putting any type of dairy into their beverage, by using the flavored melts 235 of the present invention, will be able to make their beverages more enjoyable and sweeter without the use of dairy and make their beverages less bitter with the use of the bitter blockers 215.

At a process step 110, any dry ingredients 205 are added to any wet ingredients 210 and blended until the ingredients form an approximately homogenous blended mixture 220. It is noted that any suitable method of blending may be used, while maintaining the spirit of the present invention.

At a process step 115, the blended ingredients 220 are placed in one or more molds 225, the molds 225 having a cavity 230 in the shape of a desired flavored melt 235. It is noted that any suitable cavity shape may be used while maintaining the spirit of the present invention. For example, the mold may have: a circular shape, an oval shape, a rectangular shape, a square shape, a triangular shape, a quadrilateral shape, a pentagonal shape, a hexagonal shape, a heptagonal shape, an octagonal shape, a nonagonal shape, or a decagonal shape, among others not explicitly listed herein. According to an embodiment, the blended ingredients 220 are firmly pressed into the molds 225. According to an embodiment, excess blended ingredients 220 is removed from the molds 225, ensuring smooth edges of the flavored melts 235.

According to an embodiment, once the blended ingredients 220 are placed in the molds 225, the molded blended ingredients 220, at a process step 120, are removed from the molds 225 and, at a process step 125, baked. According to an embodiment, the baking process involves baking the ingredients 220 at approximately 250° F. (e.g., about 121° C.) for approximately one hour. It is noted, however, that, depending on the desired ingredients, texture, appearance, etc., that other temperatures and timeframes may be used to prepare the flavored melts 235, while maintaining the spirit of the present invention. According to various embodiments, one or more heating methods 240 may be used to bake the blended ingredients 220. These heating methods may include, e.g., a rotating rack over, a band over, a dehydrator, a drying/heated room, and/or any other suitable heating method.

At process step 130, the baked ingredients are cooled, forming the flavored melts 235. According to an embodiment, the ingredients are left to air-cool. According to an embodiment, the ingredients are cooled using a refrigeration device 245. Once the ingredients are cooled, the flavored melts 235, at step 135, are packaged for sale and/or use. According to an embodiment, each flavored melt 235 is individually packaged.

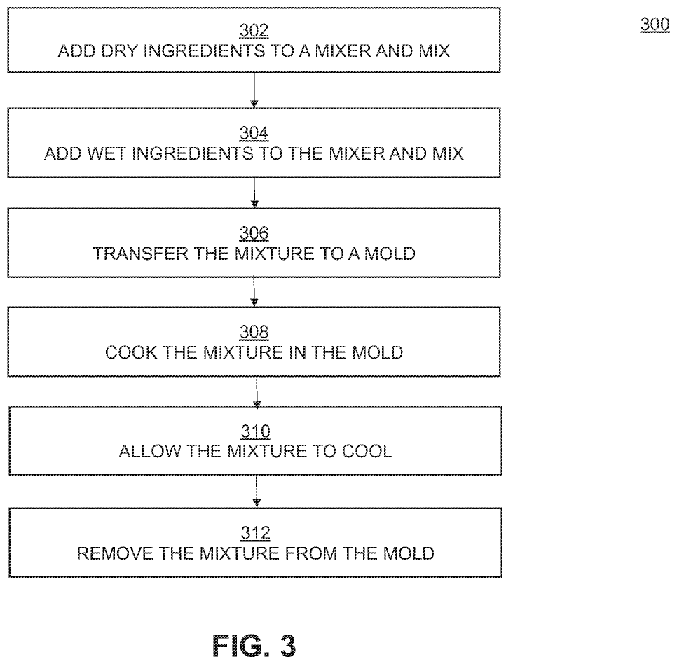

FIG. 3 depicts another method 300 for forming flavored melts. The method 300 of FIG. 3 begins with a process step 302 that includes adding the dry ingredients 205 to a mixer (e.g., a paddle mixer) and mixing the dry ingredients 205. The dry ingredients 205 are mixed on low speed for 5-10 minutes or until the dry ingredients 205 are homogenous.

A process step 304 follows the process step 302 and includes adding the wet ingredients 210 to the mixture and mixing the wet ingredients 210 with the dry ingredients 205 for about 10 minutes until the ingredients are uniform. A process step 306 follows the process step 304 and includes transferring the mixture to the mold 225, filling the mold 225 completely, and pressing firmly into the cavities of the mold 225. A scraper or similar device is used to scrape off excess sugar to ensure a smooth bottom to the flavored melt 235. In some embodiments, the mold 225 may be filled with about 0.25-0.4 pounds of the mixture.

A process step 308 follows the process step 306 and includes cooking the mixture in the mold 225 at about 250° F. (e.g., about 121° C.) for a time period between 30 minutes and 1 hour. A process step 310 follows the process step 308 and includes allowing the mixture to cool. A process step 312 follows the process step 310 and includes removing the mixture from the mold 225 and, optionally packaging the flavored melt 235. The process step 312 concludes the method of FIG. 3.

### EXAMPLES

### Example 1

### Caramel Flavored Melt Formulation

The method 100 of FIG. 1 or the method 300 of FIG. 3 may be used to form the caramel flavored melt formulation of Example 1. The dry ingredients 205 include: baker's sugar (e.g., between about 80-90 wt. %), dark brown sugar (e.g., between about 1-6 wt. %), caramel powder (e.g., between about 1-6 wt. %), a TIC gum (e.g., between about 0.5-5 wt. %), and/or salt (e.g., between about 0.05-0.30 wt. %). The wet ingredients 210 may include: water (e.g., between about 1-6 wt. %) and/or a caramel coloring (e.g., between about 10-15 wt. %). Moreover, the wet ingredients 210 and/or dry ingredients 205 include one or more bitter blockers 215 (e.g., between about 0.05-0.30 wt. %).

### Example 2

### Hazelnut Flavored Melt Formulation

The method 100 of FIG. 1 or the method 300 of FIG. 3 may be used to form the hazelnut flavored melt formulation of Example 2. The dry ingredients 205 include: baker's sugar (e.g., between about 80-90 wt. %), a TIC gum (e.g., between about 0.5-5 wt. %), and/or salt (e.g., between about 0.05-0.30 wt. %). The wet ingredients 210 may include: water (e.g., between about 1-6 wt. %), a coloring component (e.g., between about 0.01-0.1 wt. %), and/or a liquid hazelnut flavoring (e.g., between about 1-6 wt. %). Moreover, the wet ingredients 210 and/or dry ingredients 205 include one or more bitter blockers 215 (e.g., between about 0.05-0.30 wt. %).

### Example 3

### French Vanilla Flavored Melt Formulation

The method 100 of FIG. 1 or the method 300 of FIG. 3 may be used to form the French vanilla flavored melt formulation of Example 3. The dry ingredients 205 include: baker's sugar (e.g., between about 80-90 wt. %), a TIC gum (e.g., between about 1-5 wt. %), and/or salt (e.g., between about 0.05-0.30 wt. %). The wet ingredients 210 may include: water (e.g., between about 1-6 wt. %), a coloring component (e.g., between about 0.01-0.1 wt. %), and/or at least one vanilla flavoring component (e.g., between about 5-10 wt. %). Moreover, the wet ingredients 210 and/or dry ingredients 205 include one or more bitter blockers 215 (e.g., between about 0.05-0.30 wt. %).

### Example 4

### Chocolate Flavored Melt Formulation

The method 100 of FIG. 1 or the method 300 of FIG. 3 may be used to form the chocolate flavored melt formulation of Example 4. The dry ingredients 205 include: baker's sugar (e.g., between about 80-90 wt. %) and/or salt (e.g., between about 0.05-0.30 wt. %). The wet ingredients 210 may include: water (e.g., between about 1-6 wt. %), a coloring component (e.g., between about 0.01-0.1 wt. %), and/or at least one chocolate flavoring powder or cocoa powder (e.g., between about 5-10 wt. %). Moreover, the wet ingredients 210 and/or dry ingredients 205 include one or more bitter blockers 215 (e.g., between about 0.05-0.30 wt. %).

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A flavored melt, comprising:
a baked sugar composition, the baked sugar composition including:
an amount of sugar in a range of about 1 to about 90 wt. %;
an amount of water in a range of about 1 to about 6 wt. %;
an amount of one or more natural or artificial flavorings in a range of about 1 to about 10 wt. %; and
an amount of one or more bitter blockers in a range of about 0.05 to 0.30 wt. %.

2. The flavored melt as recited in claim 1, wherein the baked sugar composition is formed into a desired shape using a mold.

3. The flavored melt as recited in claim 1, wherein the sugar includes one or more sugars selected from the group consisting of baker's sugar; brown sugar; dark brown sugar; and caramel powder.

4. The flavored melt as recited in claim 1, wherein the one or more natural or artificial flavorings are selected from the group consisting of chocolate flavored powder, cocoa powder; and vanilla flavor.

5. The flavored melt as recited in claim 1, wherein the baked sugar composition further includes an amount of food coloring in a range of about 0.01 to about 15 wt. %.

6. The flavored melt as recited in claim 1, wherein the baked sugar composition further includes an amount of salt in a range of about 0.05 to about 0.30 wt. %.

7. The flavored melt as recited in claim 1, wherein the baked sugar composition further includes sodium carboxymethylcellulose.

8. A method for forming a flavored melt, comprising:
blending a plurality of ingredients of a baked sugar composition, wherein the plurality of ingredients includes: an amount of sugar in a range of about 1 to about 90 wt. %, an amount of water in a range of about 1 to about 6 wt. %, an amount of one or more natural or artificial flavorings in a range of about 1 to about 10 wt. %, and an amount of one or more bitter blockers in a range of about 0.05 to 0.30 wt. %;
placing the blended ingredients into an internal cavity of a mold;
removing the blended ingredients from the mold, wherein the blended ingredients retain a shape of the internal cavity; and
baking the blended ingredients in the shape of the internal cavity, forming the flavored melt.

9. The method as recited in claim 8, wherein the sugar includes one or more sugars selected from the group consisting of: baker's sugar; brown sugar; dark brown sugar; and caramel powder.

10. The method as recited in claim 8, wherein the one or more natural or artificial flavorings are selected from the group consisting of: chocolate flavored powder; cocoa powder; and vanilla flavor.

11. The method as recited in claim 8, wherein the baked sugar composition further includes an amount of food coloring in a range of about 0.01 to about 15 wt. %.

12. The method as recited in claim 8, wherein the baked sugar composition further includes an amount of salt in a range of about 0.05 to about 0.30 wt. %.

13. The method as recited in claim 8, wherein the baked sugar composition further includes sodium carboxymethylcellulose.

14. The method as recited in claim 8, further comprising:
cooling the flavored melt after baking the blended ingredients.

15. The method as recited in claim 14, further comprising:
packaging the flavored melt after cooling the flavored melt.
